(19) United States
(12) Patent Application Publication
(10) Pub. No.: US 2024/0372289 A1
(43) Pub. Date: Nov. 7, 2024

(54) DUAL LOCKING SYSTEM

(71) Applicant: Aptiv Technologies AG, Schaffhausen (CH)

(72) Inventors: Romain SAVINA, Brethencourt (FR); Uvaraj Ganesan, Chennai (IN); Sylvain Loas, Saint Denis (FR); Laurent Delescluse, Saintpiat (FR)

(21) Appl. No.: 18/652,100

(22) Filed: May 1, 2024

(30) Foreign Application Priority Data
May 1, 2023 (IN) 202341030990

(51) Int. Cl. H01R 13/436; H01R 13/631

(52) U.S. Cl. CPC H01R 13/4365; H01R 13/631

(57) ABSTRACT

A connector assembly includes a connector and a counter-connector. The connector comprises a connector housing, a CPA device slidably mounted on the connector housing between an initial position and a final position. The connector further includes a safety locking member which is slidably mounted on the connector between an open position in which the safety locking member is attached to the connector and in which the safety locking member leaves both the CPA device and the counter-connector free to be moved with respect to the connector and a closed position in which the safety locking member prevents a movement of both the CPA device and the counter-connector with respect to the connector.

### CROSS-REFERENCE TO RELATED APPLICATION

This application claims the benefit of and priority to Indian patent application No. 202341030990 titled “Dual Locking System” filed on May 1, 2023, the contents of which are incorporated by reference herein.

### TECHNICAL FIELD

The present disclosure in general relates to establishing a secured locking between a connector position assurance (CPA) device and a connector assembly. More particularly, the disclosure relates to a safety lock mechanism having Dual Lock System (DLS) to prevent opening of CPA device for a connector of the connector assembly.

### BACKGROUND

There a demand for increasing the reliability of the mating between a connector and a counter-connector, as well as for the stability for the connection between their electrical terminals. Connector position assurance (CPA) devices are therefore necessary to guarantee proper mating and positioning of the connectors in connector assemblies, as well as to avoid unintentional connector un-mating. The connector assembly generally includes a male connector and a female connector. One can note that the terms “male” or “female” connectors refers, for example, to the kind of terminals, respectively male or female, accommodated in these respective types of connectors.

In example embodiments disclosed below, a female cable connector is mated with a male cable connector. However, more generally, the connector and counter-connector can be of any type (plug, socket, etc.). To create a reliable and secured connection between the female connector and male connector, the CPA function is introduced to the female connector by installing the CPA device therein or thereon. Further, a terminal position assurance (TPA) device can also be introduced into the female connector to ensure a secure connection of electrical terminals.

However, there are instances where the CPA device may open, or get detached from the connector assembly. Therefore, there exists further room for improvement to locking and securing the CPA device. Accordingly, the inventors felt the need to design an improved safety locking system (SLS) to prevent opening of a CPA device.

### SUMMARY

Accordingly, it is disclosed below an improved connector assembly including a connector and a counter-connector configured to be mated in a mating direction. The connector includes a connector housing, at least one terminal, configured to be inserted in a cavity formed in the connector housing, and a CPA device slidably mounted on the connector housing between an initial position and a final position. The movement of the CPA device between the initial position and the final position is released by the mating of the connector with the counter-connector.

The connector further includes a safety locking member which is slidably mounted on the connector between an open position in which the safety locking member is attached to the connector and in which the safety locking member leaves both the CPA device and the counter-connector free to be moved with respect to the connector and a closed position in which the safety locking member prevents a movement of both the CPA device and the counter-connector with respect to the connector.

In other words, the present disclosure relates to a connector assembly in which not only is the CPA device prevented from being inadvertently opened and/or detached, but the connector assembly is provided with a system which robustly reinforces the maintenance of the connection between the connector and the counter-connector.

Advantageously, this connector assembly possibly includes one or more of the following features, each one of these features being considered independently of each other or in combination of one or several others.

The safety locking member is configured to be moved between the open position and the closed position in a mounting direction perpendicular to the mating direction;

The safety locking member includes a CPA locking feature configured to prevent a movement of the CPA device with respect to the connector when the safety locking member is in closed position, this CPA locking feature extending essentially parallel to the mounting direction;

The CPA locking feature also prevents a movement of the counter-connector with respect to the connector when the safety locking member is in closed position;

The safety locking member includes a counter-connector locking feature configured to prevent a movement of the counter-connector with respect to the connector when the safety locking member is in closed position, this counter-connector locking feature extending essentially parallel to the mounting direction;

The safety locking member includes a SLS pre-lock latch which is configured to prevent a displacement of the safety locking member from the open position to the closed position when the counter-connector is not fully mated with the connector;

The SLS pre-lock latch is configured to be blocked by the housing, in the open position, so as to prevent the displacement of the safety locking member from the open position to the closed position, when the counter-connector is not mated or fully mated with the connector; this gives an indication that could warn an operator, for example, that the connector and counter-connector are not correctly mated; it also prevents the safety locking member from closing inadvertently during transport or other operations and requiring additional handling to open it again;

The SLS pre-lock latch is configured to engage the counter-connector, when the counter-connector is mated with the connector, so as to release the SLS pre-lock latch and allow the displacement of the safety locking member from the open position to the closed position;

The safety locking member includes a SLS locking latch configured to keep the safety locking member slidingly mounted on the housing; this prevents the safety locking member from being lost;

The safety locking member has a U-shape with two legs extending essentially parallel to the mounting direction and a beam extending essentially perpendicular to the mounting direction, the safety locking member being mounted astride the connector housing over at least a portion of the CPA device and a portion of the counter-connector; this provides a compact connector assembly.

According to another aspect, it is disclosed below a method of assembling and mating, in a mating direction, a connector with a counter-connector, the connector including a connector housing, at least one terminal accommodated in a cavity formed in the connector housing, and a CPA device slidably mounted on the connector housing. This method includes the steps of:
mating the connector with the counter-connector,
moving the CPA device between an initial position and a final position, the movement of the CPA device between the initial position and the final position being enabled by the mating of the connector with the counter-connector,
moving a safety locking member which is slidably mounted on the connector, between an open position in which the safety locking member is attached to the connector and in which the safety locking member leaves both the CPA device and the counter-connector free to be moved with respect to the connector and a closed position in which the safety locking member prevents a movement of both the CPA device and the counter-connector with respect to the connector.

### BRIEF DESCRIPTION OF THE DRAWINGS

The present invention is now described, by way of example with reference to the accompanying drawings, in which:

FIG. 1 is a schematic representation in perspective of a first example embodiment of connector assembly (not mated) according to some embodiments.

FIG. 2 is a schematic exploded perspective view of the female connector of the example of connector assembly shown in FIG. 1 according to some embodiments.

FIG. 3 is a schematic perspective view of the safety locking member of the female connector shown in FIG. 2 according to some embodiments.

FIG. 4 shows the safety locking member of FIG. 3, viewed from another angle according to some embodiments.

FIG. 5 is a schematic perspective view of the CPA device of the female connector shown in FIG. 2 according to some embodiments.

FIG. 6 is a schematic perspective view of the male connector of the connector assembly shown in FIG. 1 according to some embodiments.

FIG. 7 is a schematic longitudinal cross section of a portion of the connector assembly shown in FIG. 1, with the male connector being not fully mated, the CPA device being in its initial position and the safety locking member being in open position according to some embodiments.

FIG. 8 is a schematic longitudinal cross section (along the dotted line of FIG. 9), in a plane perpendicular to the one of FIG. 7, of a portion of the connector assembly shown in FIG. 7 according to some embodiments.

FIG. 9 is a schematic longitudinal cross section similar to the one shown in FIG. 7, with the male connector being fully mated, the CPA device being between its initial position and its final position and the safety locking member being in open position according to some embodiments.

FIG. 10 is a schematic longitudinal cross section similar to the one shown in FIGS. 7 and 9, with the male connector being fully mated and the CPA device being in its final position and the safety locking member being in open position according to some embodiments.

FIG. 11 is a schematic longitudinal cross section (along the dotted line of FIG. 10) similar to the one shown in FIG. 8, but with the safety locking member being in closed position according to some embodiments.

FIG. 12 is a schematic longitudinal cross section, in another plane, of a portion of the connector assembly shown in FIG. 10, with the safety locking member in open position according to some embodiments.

FIG. 13 is an enlargement of a detail of FIG. 12 according to some embodiments.

FIG. 14 is a schematic transversal cross section (along the dotted line of FIG. 12), of a portion of the connector assembly shown in FIG. 12 according to some embodiments.

FIG. 15 is an enlargement of a longitudinal cross-section of a portion of the connector assembly shown in FIGS. 10 to 14 according to some embodiments.

FIG. 16 is a schematic longitudinal cross section of a portion of the connector assembly shown in FIG. 12, with the safety locking member in closed position according to some embodiments.

FIG. 17 is an enlargement of a longitudinal cross-section of a portion of the connector assembly shown in FIG. 16 according to some embodiments.

FIG. 18 is a schematic longitudinal cross section, in another plane, of a portion of the connector assembly shown in FIG. 16 according to some embodiments.

FIG. 19 is a schematic representation in perspective of a second example embodiment of connector assembly (not mated) according to some embodiments.

FIG. 20 is a schematic exploded perspective view of the female connector of the example of connector assembly shown in FIG. 19 according to some embodiments.

FIG. 21 is a schematic perspective view of the safety locking member of the female connector shown in FIG. 20 according to some embodiments.

FIG. 22 shows the safety locking member of FIG. 21, viewed from another angle according to some embodiments.

FIG. 23 is a schematic perspective view of the CPA device of the female connector shown in FIG. 20 according to some embodiments.

FIG. 24 is a schematic perspective view of the male connector of the connector assembly shown in FIG. 19 according to some embodiments.

FIG. 25 is a schematic longitudinal cross section of a portion of the connector assembly shown in FIG. 19, with the male connector being not fully mated, the CPA device being in its initial position and the safety locking member being in open position according to some embodiments.

FIG. 26 is a schematic longitudinal cross section (along the dotted line of FIG. 27), in a plane perpendicular to the one of FIG. 25, of a portion of the connector assembly shown in FIG. 25 according to some embodiments.

FIG. 27 is a schematic longitudinal cross section similar to the one shown in FIG. 25, with the male connector being fully mated, the CPA device being between its initial position and its final position and the safety locking member being in open position according to some embodiments.

FIG. 28 is a schematic longitudinal cross section similar to the one shown in FIGS. 25 and 27, with the male connector being fully mated and the CPA device being in its final position and the safety locking member being in open position according to some embodiments.

FIG. 29 is a schematic longitudinal cross section (along the dotted line of FIG. 28) similar to the one shown in FIG. 26, of the connector assembly shown in FIG. 28 according to some embodiments.

FIG. 30 is a schematic longitudinal cross section, in another plane, of a portion of the connector assembly shown in FIG. 28, with the safety locking member in open position according to some embodiments.

FIG. 31 is an enlargement of a detail of FIG. 32 according to some embodiments.

FIG. 32 is a schematic transversal cross section (along the dotted line of FIG. 30), of a portion of the connector assembly shown in FIG. 12 according to some embodiments.

FIG. 33 is a schematic longitudinal cross section, in another plane, of a portion of the connector assembly shown in FIG. 30, with the safety locking member in closed position according to some embodiments.

FIG. 34 is an enlargement of a longitudinal cross-section, in another plane, of a portion of the connector assembly shown in FIG. 33 according to some embodiments.

FIG. 35 is a schematic longitudinal cross section, in another plane, of a portion of the connector assembly shown in FIG. 33 according to some embodiments.

### DETAILED DESCRIPTION

In this text (in particular in the specification and claims), the orientations and the adverbs such as above, below, etc. refer to the respective orientations of the connector parts shown in the figures. The skilled person will understand that a change in these orientations will lead to a change in the meaning of these adverbs.

Two exemplary embodiments of a connector assembly 1, 101 are disclosed below.

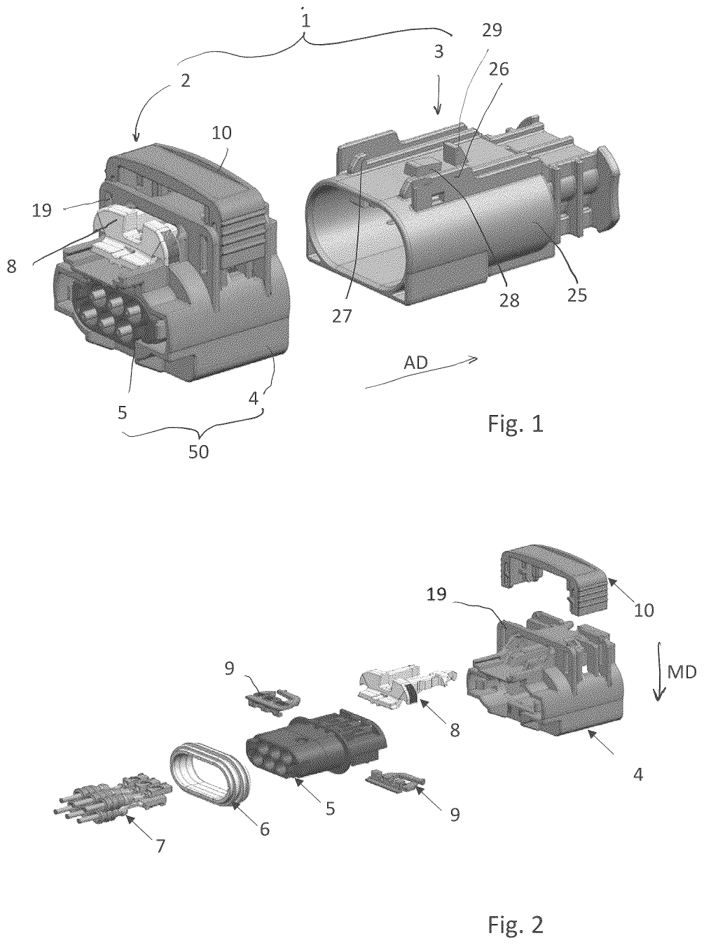

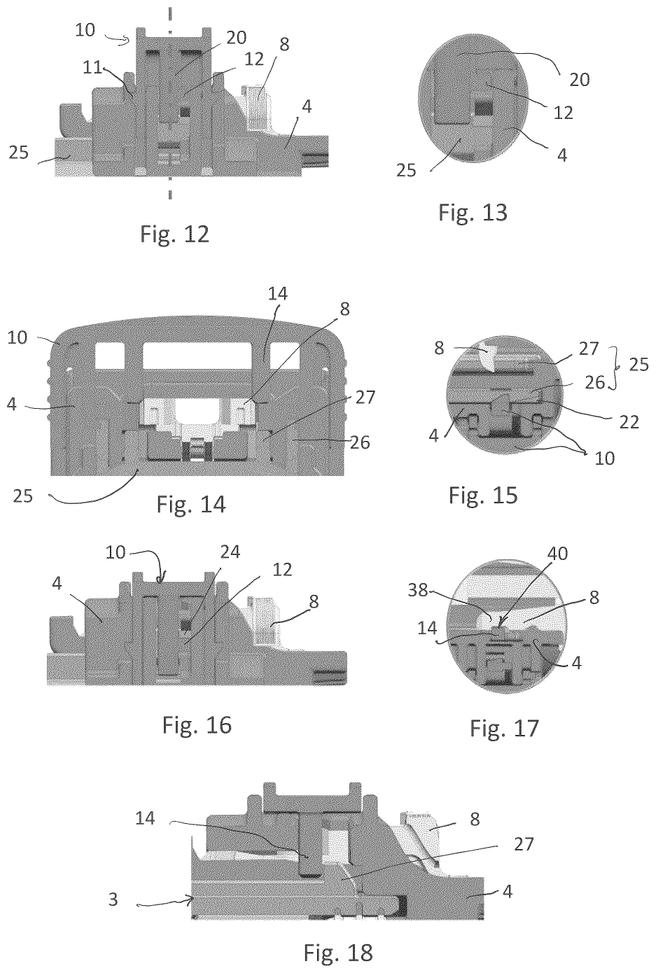

A first exemplary embodiment is illustrated with FIGS. 1 to 18. According to this first exemplary embodiment, the connector assembly 1 includes a connector 2 (e.g., a female connector) and a counter-connector 3 (e.g., a male connector)-See FIG. 1. The connector 2 and the counter-connector 3 are mated along a mating direction AD. The connector 2 includes a housing 50. In the illustrated example, the housing 50 includes two parts: an outer housing 4, an inner housing 5. The connector 2 further includes an interfacial seal 6 and electrical terminals 7 (see FIG. 2). Each terminal 7 is accommodated in a respective cavity formed in the housing 50 (this cavity being cavity formed in inner housing 5, in the illustrated example). The outer housing 4 and inner housing 5 are made of molded plastic (a dielectric material). The interfacial seal 6 is made of elastomeric material. For example, the terminals 7 are female terminals made by stamping, bending, folding, and possibly plating a sheet of metal (e.g. copper or a copper alloy). For example, these female terminals 7 are of the type marketed under the name “0.63 MQS” (MQS stands for Micro Quadlock System). For example, the connector 2 is a 6-way MQS female connector.

The counter-connector 3 has a male housing 25 made of molded plastic. The male housing 25 includes a pair of SLS activation features 26, a pair of counter-connector locking latches 27, a CPA activating feature 28 and a CPA protecting feature 29.

The connector 2 is further provided with a CPA device 8, a pair of TPA devices 9 and a safety locking member 10, all made of molded plastic.

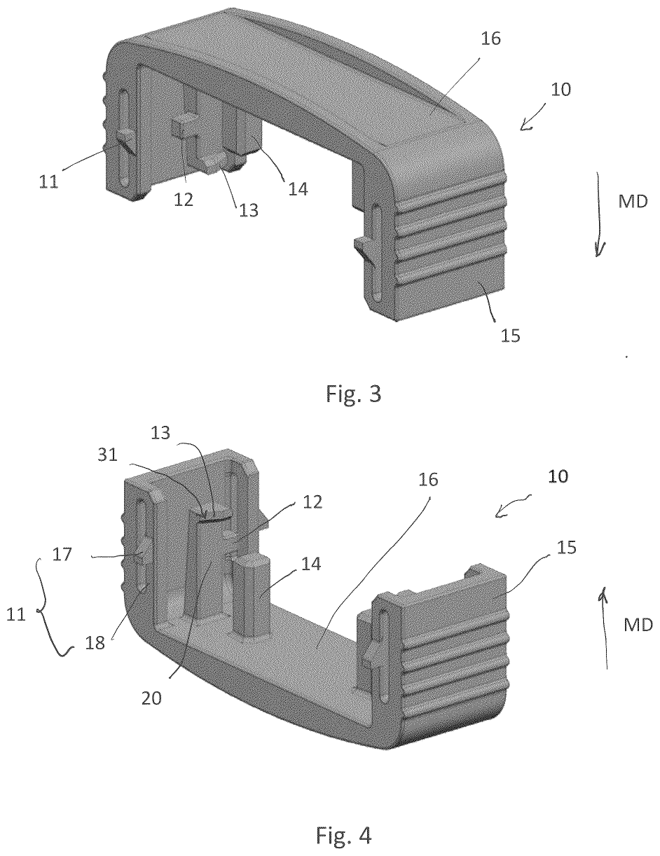

According to the first embodiment, the safety locking member 10 includes two pairs of SLS locking latches 11, a pair of SLS pre-lock latches 12, a pair of SLS activation latches 13 and a pair of CPA locking features 14 (see FIGS. 3 and 4). The safety locking member 10 is mounted on the connector 2 in a mounting direction MD, parallel to a plane essentially perpendicular to the mating direction AD (see FIG. 2). More particularly, the safety locking member 10 is mounted on the outer housing 4. The safety locking member 10 has a general U-shape, with two legs 15 extending essentially parallel to the mounting direction MD and a beam 16 extending essentially perpendicular to the mounting direction MD (see FIGS. 3 and 4).

The safety locking member 10 is kept on the outer housing 4 thanks to the SLS locking latches 11. Each SLS locking latch 11 includes a hook 17 outwardly extending from a flexible arm 18 (see FIG. 4). Each hook 17 engages a slot 19 provided on the outer housing 4 (see FIGS. 1 and 2).

The parts (i.e., the inner housing 5, the outer housing 4, the CPA device 8, etc.) forming the connector 2 are assembled together. More particularly, the safety locking member 10 is configured to be slidably mounted on the outer housing 4 between an open position and a closed position (while the hooks 17 are kept in the slots 19 and move along the slots 19). However, when mounted and placed in open position on the outer housing 4, the safety locking member 10 is prevented by the SLS pre-lock latches 12, from being further inserted in the outer housing 4 toward the closed position. More particularly, the SLS pre-lock latches 12 consist of protrusions having blocking surfaces perpendicular to the mounting direction MD, these blocking surfaces engaging the outer housing 4. The SLS activation latches 13 are configured to release the SLS pre-lock latches 12 from their engagement with the outer housing 4, when the counter-connector 3 is mated with the connector 2. For example, each SLS activation latch 13 is supported by a same branch 20 (extending essentially parallel to the mounting direction MD) as a SLS pre-lock latch 12 (Sec FIG. 4), and each SLS activation latch 13 includes a slanted surface 21 configured to slide over a respective SLS activation feature 26 of the counter-connector 3 during the assembly of the connector 2 and counter-connector 3. Possibly, the counter-connector 3 includes bevelled surfaces 22 (See FIG. 6), on the SLS activation features 26, configured to slide over the slanted surfaces 21 to help the branches 20 to spread apart. Thereby the branches 20 are bent outwardly and the SLS pre-lock latches 12 are pushed back is a clearance. The safety locking member 10 can then be pressed up to the closed position. In the closed position of safety locking member 10, each SLS activation latch 13 springs back in a notch 23 (See FIG. 6) and each SLS pre-lock latch 12 springs back in a recess 24 (Sec FIG. 16).

Each CPA locking feature 14 has a general pillar shape extending, from an inner surface of the beam 16 of the safety locking member 10, essentially parallel to the mounting direction MD (See FIG. 4).

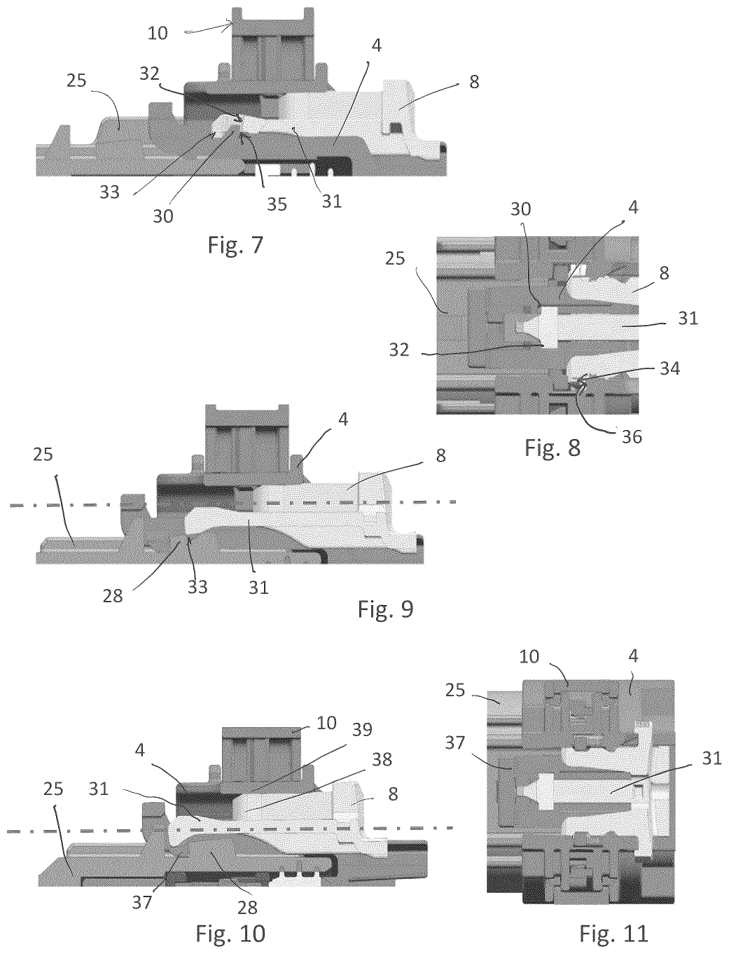

The CPA device 8 is stopped in initial (or pre-lock) position by a stop 30 located on the outer housing 4 (See FIGS. 7 and 8). More particularly, the CPA device 8 includes a locking lance 31 with a blocking surface 32 on either side of the locking lance 31, engaging first stop surfaces 35 located on the outer housing 4, so as to prevent the CPA device 8 from being moved frontwards, when the CPA device 8 is in its initial position and when the connector 2 is not mated with the counter-connector 3. The locking lance 31 also includes an activation surface 33 at its free end. Furthermore, the CPA device 8 includes locking features 34 engaging second stop surfaces 36 located on the outer housing 4, so as to prevent the CPA device 8 from being moved backwards (and removed from the connector 2) when the CPA device 8 is in its initial position (See FIG. 8). When the connector 2 is mated with the counter-connector 3, said activation surface 33 is moved upwards by the CPA activation feature 28 (e.g., in the shape of a protrusion) located on the upper face of the male housing 25, so as to bend the locking lance 31 and to release the blocking surfaces 32 from the first second stop surfaces 35 of the outer housing 4 (See FIG. 9). Then, the CPA device 8 is released from the first stop surfaces 35 and can be pushed further towards the mating face of the connector 2, up to its final position (Sec FIGS. 10 and 11).

When the CPA device 8 is in its final position, this means that the connector 2 is fully and functionally mated with the counter-connector 3. When the connector 2 and the counter-connector 3 are mated and locked together, a connector latch 37 (integral with the outer housing 104) engages the protrusion forming the CPA activation feature 28. The connector latch 37 and the CPA activation feature 28 then provide a primary locking function of the connectors.

In this configuration, the CPA device 8 can be pushed and moved to its final position.

In the final position of the CPA device 8, the CPA device 8 prevents the connector latch 37 from being bent upwards. For example, the CPA device 8 has CPA blocking branches 38 inserted (when the CPA device 8 is in final position) between an outer housing portion 39 and the connector latch 37, thereby ensuring a secondary locking function (See FIG. 10).

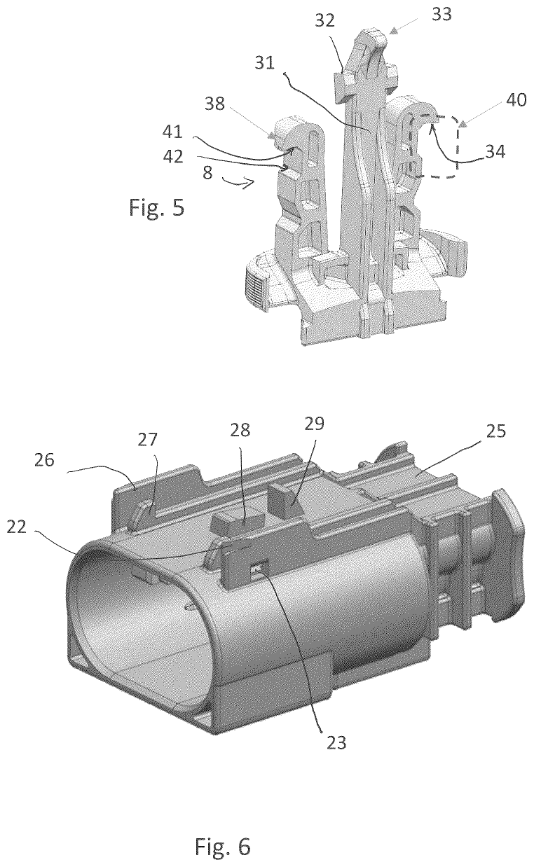

In this position, as already mentioned, the safety locking member 10 can then be pressed downwards (e.g., 3.5 mm downwards) and the CPA locking features 14 insert behind the CPA blocking branches 38 (See FIG. 17). Indeed, each blocking branch 38 has a blocking notch 40 (Sec FIG. 5). Each blocking notch 40 is open outward and has a front stop 41 and a rear stop 42. When each CPA locking feature 14 is inserted in a respective blocking notch 40, the CPA blocking branches 38 are blocked laterally by the CPA locking features 14 and cannot spread apart. Further, in this configuration, each CPA locking feature 14 can engage the front stop 41 and a rear stop 42 so as to prevent the CPA device 8 from being moved frontwards or backwards. But the CPA locking features 14 of the safety locking member 10 also cooperates with the counter-connector locking latches 27 of the counter-connector 3 (See FIG. 18). This prevents the connector 2 and counter-connector 3 from being inadvertently unmated and disconnected.

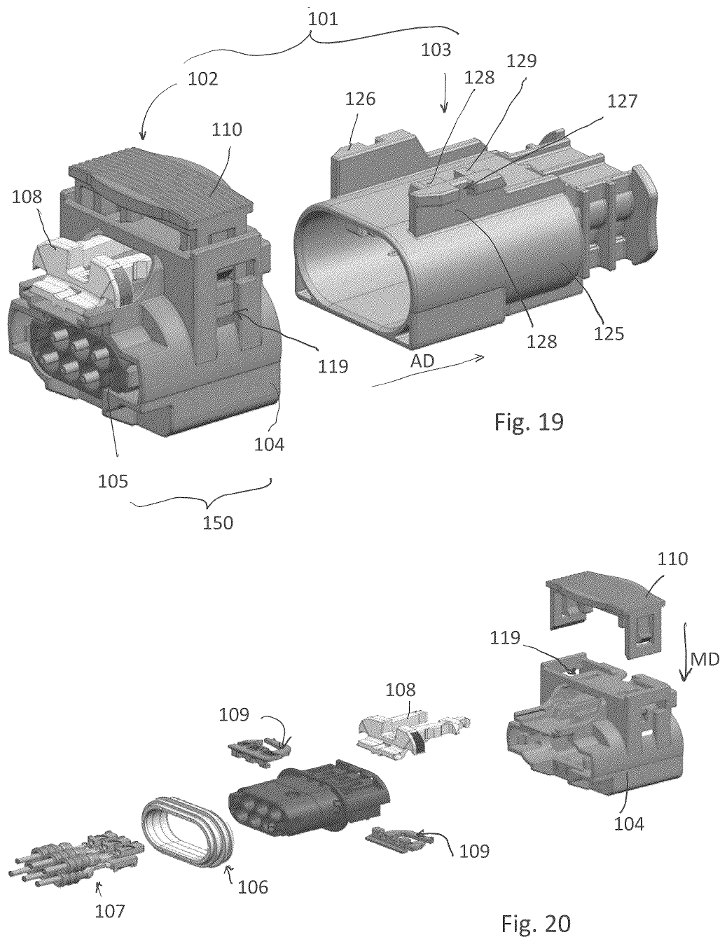

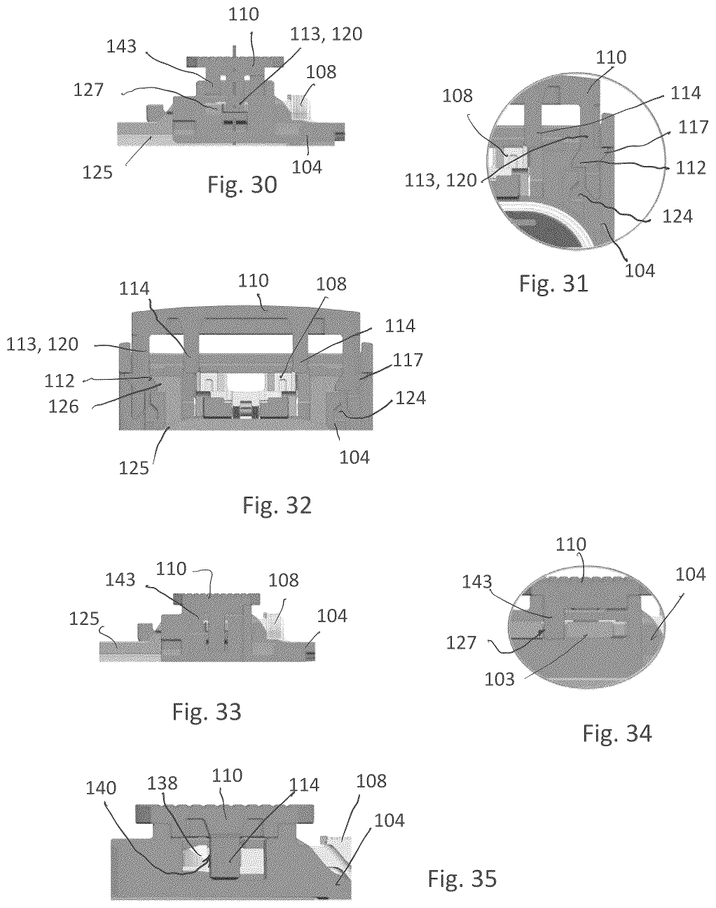

A second exemplary embodiment is illustrated with FIGS. 19 to 35. According to this second exemplary embodiment, the connector assembly 101 includes a connector 102 (e.g., a female connector) and a counter-connector 103 (e.g., a male connector)-See FIG. 19. The connector 102 and the counter-connector 103 are mated along a mating direction AD. The connector 102 includes a housing 150. In the illustrated example, the housing 150 includes two parts: an outer housing 104, an inner housing 105. The connector 102 further includes an interfacial seal 106 and electrical terminals 107 (see FIG. 20). Each terminal 107 is accommodated in a respective cavity formed in the housing 150 (this cavity being formed in inner housing 105, in the illustrated example). The outer housing 104 and inner housing 105 are made of molded plastic (a dielectric material). The interfacial seal 106 is made of elastomeric material. For example, the terminals 107 are female terminals made by stamping, bending, folding, and possibly plating a sheet of metal (e.g. copper or a copper alloy). For example, these female terminals 107 are of the type marketed under the name “0.63 MQS” (MQS stands for Micro Quadlock System). For example, the connector 102 is a 6-way MQS female connector.

The counter-connector 103 has a male housing 125 made of molded plastic. The male housing 125 includes a pair of SLS activation features 126, a pair of counter-connector locking latches 127, a CPA activating feature 128 and a CPA protecting feature 129.

The connector 102 is further provided with a CPA device 108, a pair of TPA devices 109 and a safety locking member 110, all made of molded plastic.

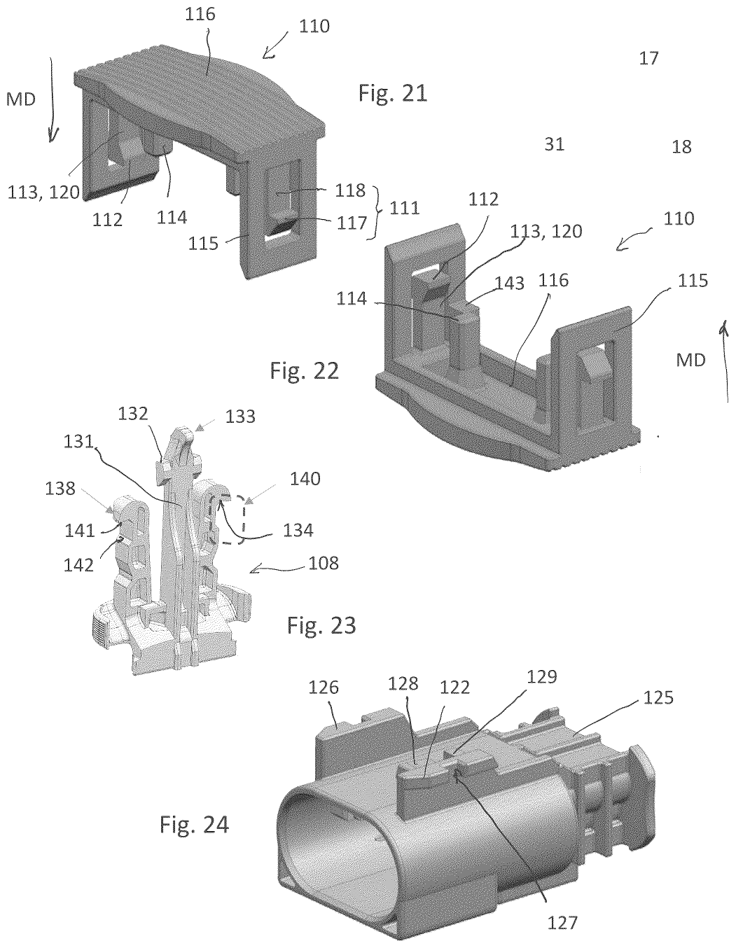

According to the second embodiment, the safety locking member 110 includes on pair of SLS locking latches 111, a pair of SLS pre-lock latches 112, a pair of SLS activation latches 113, a pair of CPA locking features 114 and a pair of counter-connector locking features 143 (see FIGS. 21 and 22). The safety locking member 110 is mounted on the connector 102 in a mounting direction MD, parallel to a plane essentially perpendicular to the mating direction AD (see FIG. 20). More particularly, the safety locking member 110 is mounted on the outer housing 104. The safety locking member 110 has a general U-shape, with two legs 115 extending essentially parallel to the mounting direction MD and a beam 116 extending essentially perpendicular to the mounting direction MD.

The safety locking member 110 is kept on the outer housing 104 thanks to the SLS locking latches 111. Each SLS locking latch 111 includes a hook 117 outwardly extending from a flexible arm 118. Each hook 117 engages a slot 119 provided on the outer housing 104 (see FIGS. 19 and 20).

The parts (i.e., the inner housing 105, the outer housing 104, the CPA device 108, etc.) forming the connector 102 are assembled together. More particularly, the safety locking member 110 is configured to be slidably mounted on the outer housing 104 between an open position and a closed position (while the hooks 117 are retained in the slots 119 and move along the slots 119). However, when mounted and placed in open position on the outer housing 104, the safety locking member 110 is prevented by the SLS pre-lock latches 112, from being further inserted in the outer housing 104 toward the closed position. More particularly, the SLS pre-lock latches 112 consist of protrusions having blocking surfaces perpendicular to the mounting direction MD, these blocking surfaces engaging the outer housing 104. The SLS activation latches 113 are configured to release the SLS pre-lock latches 112 from their engagement with the outer housing 104, when the counter-connector 103 is mated with the connector 102. For example, each SLS activation latch 113 consists in a branch 120 (extending essentially parallel to the mounting direction MD) supporting a SLS pre-lock latch 112 (Sec FIG. 21). Each SLS activation latch 113 is configured to slide over a respective SLS activation feature 126 of the counter-connector 103 during the assembly of the connector 102 and counter-connector 103. Indeed, the counter-connector 103 includes bevelled surfaces 122 (see FIG. 24), on the SLS activation features 126, to help the branches 120 to spread apart. Thereby the branches 120 are bent outwardly and the SLS pre-lock latches 112 are pushed back is a clearance. The safety locking member 110 can then be pressed up to the closed position. In the closed position of safety locking member 110 and each SLS pre-lock latch 112 springs back in a recess 124 (see FIG. 32).

Each CPA locking feature 114 has a general pillar shape extending, from an inner surface of the beam 116 of the safety locking member 110, essentially parallel to the mounting direction MD (See FIG. 22).

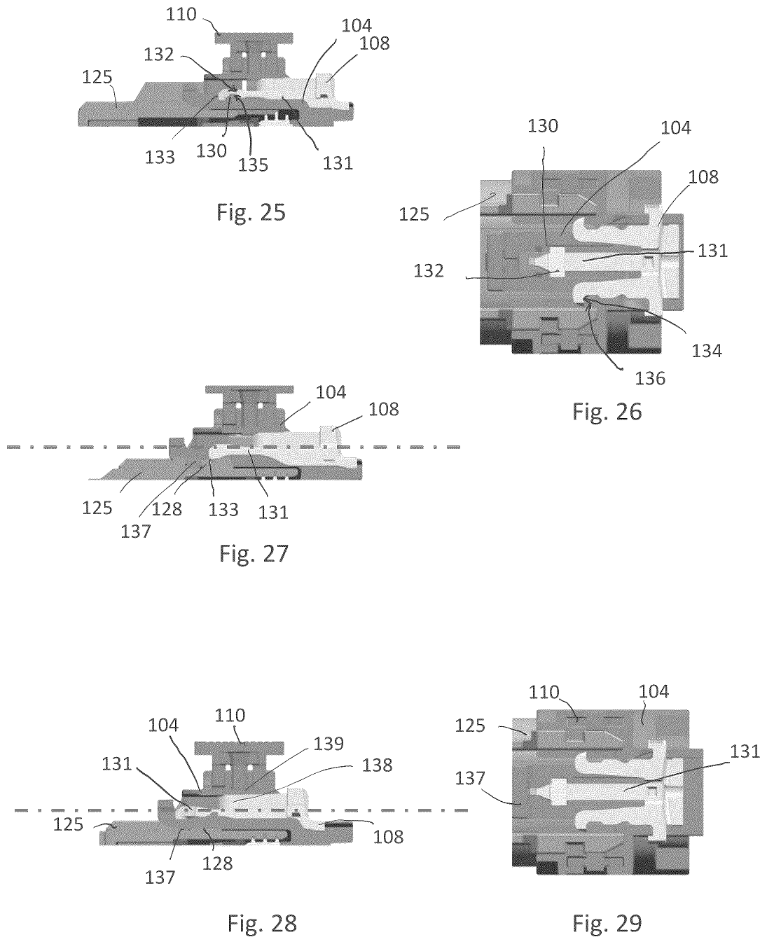

The CPA device 108 is stopped in initial (or pre-lock) position by a stop 130 located on the outer housing 104 (See FIGS. 25 and 26). More particularly, the CPA device 108 includes a locking lance 131 with a blocking surface 132 on either side of the locking lance 131, engaging first stop surfaces 135 located on the outer housing 104, so as to prevent the CPA device 108 from being moved frontwards, when the CPA device 108 is in its initial position and when the connector 102 is not mated with the counter-connector 103. The locking lance 131 also includes an activation surface 133 at its free end. Furthermore, the CPA device 108 includes locking features 134 engaging second stop surfaces 136 located on the outer housing 104, so as to prevent the CPA device 108 from being moved backwards (and removed from the connector 102) when the CPA device 108 is in its initial position (Sec FIG. 26). When the connector 102 is mated with the counter-connector 103, said activation surface 133 is moved upwards by the CPA activation feature 128 (e.g., in the shape of a protrusion) located on the upper face of the male housing 125, so as to bend the locking lance 131 and to release the blocking surfaces 132 from the first second stop surfaces 135 of the outer housing 104 (See FIG. 27). Then, the CPA device 108 is released from the first stop surfaces 135 and can be pushed further towards the mating face of the connector 102, up to its final position (See FIGS. 28 and 29).

When the CPA device 108 is in its final position, this means that the connector 102 is fully and functionally mated with the counter-connector 103. When the connector 102 and the counter-connector 103 are mated and locked together, a connector latch 137 (integral with the outer housing 104) engages the protrusion forming the CPA activation feature 128. The connector latch 137 and the CPA activation feature 128 then provide a primary locking function of the connectors.

In this configuration, the CPA device 108 can be pushed and moved to its final position.

In the final position of the CPA device 108, the CPA device 108 prevents the connector latch 137 from being bent upwards. For example, the CPA device 108 has CPA blocking branches 138 inserted (when the CPA device 108 is in final position) between an outer housing portion 139 and the connector latch 137, thereby ensuring a secondary locking function (See FIG. 28).

In this position, as already mentioned, the safety locking member 110 can then be pressed downwards (e.g., 3.5 mm downwards) and the CPA locking features 114 insert behind the CPA blocking branches 138 (See FIG. 35). Indeed, each blocking branch 138 has a blocking notch 140 (See FIG. 23). Each blocking notch 140 is open outward and has a front stop 141 and a rear stop 142. When each CPA locking feature 114 is inserted in a respective blocking notch 140, the CPA blocking branches 138 are blocked laterally by the CPA locking features 114 and cannot spread apart. Further, in this configuration, each CPA locking feature 114 can engage the front stop 141 and a rear stop 142 so as to prevent the CPA device 108 from being moved frontwards or backwards. Further, the counter-connector locking features 143 of the safety locking member 110 also cooperates with the counter-connector locking latches 127 of the counter-connector 103 (See FIGS. 33 and 34). This prevents the connector 102 and counter-connector 103 from being inadvertently unmated and disconnected.

Numerous versions of the design described above are possible. For example, the number of SLS locking latches 11, 111, of SLS pre-lock latches 12, 112, of SLS activation latches 13, 113, of CPA locking features 14, of counter-connector locking features 143, etc. may vary. The respective shapes of the various elements forming the connector 2, 102 and counter-connector 3, 103 may also vary.

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. A connector assembly, comprising:
a connector further comprising:
a connector housing,
at least one terminal configured to be inserted in a cavity formed in the connector housing;
a counter-connector configured to be mated with the connector in a mating direction; and
a CPA device slidably mounted on the connector housing between an initial position and a final position, wherein movement of the CPA device between the initial position and the final position is released by the mating of the connector with the counter-connector, wherein the connector further comprises a safety locking member which is slidably mounted on the connector between an open position in which the safety locking member is attached to the connector and in which the safety locking member leaves both the CPA device and the counter-connector free to be moved with respect to the connector and a closed position in which the safety locking member prevents a movement of both the CPA device and the counter-connector with respect to the connector.

2. The connector assembly according to claim 1, wherein the safety locking member is configured to be moved between the open position and the closed position in a mounting direction perpendicular to the mating direction.

3. The connector assembly according claim 2, wherein the safety locking member comprises a CPA locking feature configured to prevent a movement of the CPA device with respect to the connector when the safety locking member is in closed position, this CPA locking feature extending essentially parallel to the mounting direction.

4. The connector assembly according claim 3, wherein the CPA locking feature also prevents a movement of the counter-connector with respect to the connector when the safety locking member is in closed position.

5. The connector assembly according to claim 3, wherein the safety locking member comprises a counter-connector locking feature configured to prevent a movement of the counter-connector with respect to the connector when the safety locking member is in closed position, this counter-connector locking feature extending essentially parallel to the mounting direction.

6. The connector assembly according to claim 1, wherein the safety locking member comprises a SLS pre-lock latch which is configured to prevent a displacement of the safety locking member from the open position to the closed position when the counter-connector is not fully mated with the connector.

7. The connector assembly according to claim 6, wherein the SLS pre-lock latch is configured to be blocked by the housing, in the open position, so as to prevent the displacement of the safety locking member from the open position to the closed position, when the counter-connector is not fully mated with the connector.

8. The connector assembly according to any claim 7, wherein the SLS pre-lock latch is configured to engage the counter-connector, when the counter-connector is mated with the connector, so as to release the SLS pre-lock latch and allow the displacement of the safety locking member from the open position to the closed position.

9. The connector assembly according to claim 1, wherein the safety locking member comprises a SLS locking latch configured to keep the safety locking member slidingly mounted on the housing.

10. The connector assembly according to claim 1, wherein the safety locking member has a U-shape with two legs extending essentially parallel to the mounting direction and a beam extending essentially perpendicular to the mounting direction, wherein the safety locking member is mounted astride the connector housing over at least a portion of the CPA device and a portion of the counter-connector.

11. A method of assembling and mating, in a mating direction, a connector with a counter-connector, the connector having a connector housing, at least one terminal accommodated in a cavity formed in the connector housing, and a CPA device slidably mounted on the connector housing, the method comprising:
mating the connector with the counter-connector;
moving the CPA device between an initial position and a final position, wherein movement of the CPA device between the initial position and the final position is enabled by the mating of the connector with the counter-connector; and
moving a safety locking member which is slidably mounted on the connector, between an open position in which the safety locking member is attached to the connector and in which the safety locking member leaves both the CPA device and the counter-connector free to be moved with respect to the connector and a closed position in which the safety locking member prevents a movement of both the CPA device and the counter-connector with respect to the connector.
